(19) United States
(12) Patent Application Publication
(10) Pub. No.: US 2006/0082033 A1
(43) Pub. Date: Apr. 20, 2006

(54) Process for the dimensionally-true sintering of ceramics

(76) Inventors: Holger Hauptmann, Sindelsdorf (DE); Bernd Burger, Alling (DE); Robert Schnagl, Landsberg (DE); Ingo Wagner, Herrsching (DE)

Correspondence Address: BIRCH STEWART KOLASCH & BIRCH, PO BOX 747, FALLS CHURCH, VA, 22040-0747, US

(21) Appl. No.: 11/290,565

(22) Filed: Dec. 1, 2005

Related U.S. Application Data
(63) Continuation of application No. 09/890,804, filed on Oct. 1, 2001.

(30) Foreign Application Priority Data
Feb. 4, 1999 (DE) 199 04 523.2

(51) Int. Cl. C04B 33/32

(52) U.S. Cl. 264/605

(57) ABSTRACT

A process for the dimensionally-true sintering of ceramic pre-shaped items, in which the firing material is resting during sintering on supporting devices, not coated with metal, which independently adapt to the shrinkage dimensions which occur during the firing process or allow a contact-free support of the pre-shaped items.

### CROSS-REFERENCE TO RELATED APPLICATIONS

This application is a 37 C.F.R. § 1.53(b) continuation of U.S. application Ser. No. 09/890,804 filed on Oct. 1, 2001, which claims priority on PCT International Application No. PCT/EP00/00909 filed Feb. 4, 2000, which in turn claims priority on German Patent Application No. DE 199 04 523.2 filed Feb. 4, 1999. Each of these applications is hereby incorporated by reference.

### BACKGROUND OF THE INVENTION

The invention relates to a process for the dimensionally-true sintering of free-form flat ceramics. In particular, the invention relates to a process for dimensionally-true sintering of dental prostheses prepared from dental ceramics.

Because of their physical properties, ceramics are much valued in the construction of high-quality pre-shaped parts, for example dentures and are, therefore, ever more widely used. Upon sintering of ceramic materials, a volume reduction (shrinkage) always takes place. During the firing process parts of the object to be sintered perform a movement relative to a rigid, non-movable firing base. With filigree works which are used in particular in the field of dentures, the free movability is hampered by minor hooking effects on the firing base, a considerable deformation of the object thereby occurring. This state of affairs is particularly critical with bridges which are composed for example of two caps and a crosspiece connecting them: a deformation of the original geometry of the bridge occurs which has a very adverse effect on the accuracy of fit of the prosthetic work.

Usually, powders are used to reduce the friction between firing material and firing base. At higher sinter temperatures, however, either reactions between powder and firing material, or a caking of the powder fill caused by the development of sinter necks, occurs. In both cases, this can lead to the effect described above and thus to the unusability of the firing material. Because of the preform's own weight, deformation of the preform structures can also occur in systems which display super-elasticity. This effect occurs with bridges in particular.

It is known from DD-121 025 to fire mouldings formed bodies on firing bases which are coated with molybdenum. Such processes are in principle unsuitable for high quality ceramic work pieces, as a contamination of the ceramic by metal parts occurs because of diffusion processes.

### BRIEF SUMMARY OF THE INVENTION

The object of this invention is to provide a process which allows a dimensionally-true sintering of ceramic pre-shaped items.

This object is achieved according to the invention by resting the firing material during the sintering on supporting materials, not coated with metal, which adapt independently to the shrinkage dimensions which occur during the firing process or allow a contact-free support of the pre-shaped items.

The supporting materials according to the invention can be designed in completely differently ways. The design shapes can in principle be divided into the following groups:
I. Resting of the firing material on movable supporting materials which can be composed of any material, for example based on sintered aluminium oxide, which is inert vis-à-vis the firing process and does not result in adhesion to the firing material and does not contaminate the latter.
II. Resting of the firing material on supporting materials which have the same physical properties as the firing material itself. Preferably, the support is composed of the same material as the firing material, for example based on zirconium oxide or aluminium oxide.
III. Resting of the firing material on supporting materials which have very different physical properties to the firing material itself, in which case a contamination or bonding of the firing material with the supporting material must not be possible.
IV. Resting of the firing material on supporting materials which allow a contact-free support.

### BRIEF DESCRIPTION OF THE DRAWINGS

FIG. 1 shows by way of example the attachment of two S-shaped hooks (X) at a fixed position (Y) within a firing chamber (Z), the firing material (A) already being fitted onto the hooks.

FIG. 2 shows by way of example the attachment of the two S-shaped hooks (X) inside the firing chamber (Z), each of the hooks being freely movable on a track (S), for example over rollers, and thus being able to yield to the forces which occur during the firing process and the firing material (A) already being fitted onto the hooks.

FIG. 3 shows that the hooks can also be suspended in a bar-shaped track structure (B), consisting of vertical elements of (B) and horizontal elements of (B), which permit a suspension of the hooks (X) which support the firing material (A).

FIG. 4 shows by way of example the attachment of two hooks (X) outside the firing chamber (Z), which is screened from the supports via a heat insulator (W), each of the hooks being freely movable on a sliding bearing (G) and thus being able to yield to the forces which occur during the firing process, and (V) is a mechanical, electronic and/or optical scanning device.

FIG. 5 shows by way of example the attachment of two props (T) for the firing material, the props being freely movable on sliding bearings (G) outside the firing chamber (Z) and thus being able to yield to the forces which occur during the firing process. (W) is a heat insulator, and (V) is a mechanical, electronic and/or optical scanning device.

FIG. 6 shows the placing of a bridge (1) on rods (2) which are housed flexibly inside so-called firing wadding (3).

FIG. 7 shows the prosthetic work (1) is laid on a roller-shaped structure (2), the distances between the rollers adjusting independently during the firing process.

FIG. 8 shows the supporting pins (3) required during the milling of the work piece (1) are left in place after the milling process so that they serve as a stable multipoint support on a level firing base with the same shrinkage behaviour.

FIG. 9 shows the preform remainder (3) serves together with the separating powder (4) as a supporting device according to the invention.

FIG. 10 shows the firing material (A) resting on two Y-shaped supports (B). Two holding pins (H) are attached to the firing material (A) which are either produced during the shaping process or attached to the firing material after the shaping process.

FIG. 11 shows the firing material (A) resting on a magnetic field which is generated by the magnetic bases or pre-shaped parts (M), the polarity of the magnets having to be such that the firing material floats away from the base. The whole device is within firing chamber (Z), and magnets (M) can be used.

FIG. 12 shows the firing material (A) resting on gas streams (L), the latter exiting through a base plate provided with throughflow openings. The devices are located inside the firing chamber (Z).

### DETAILED DESCRIPTION OF THE INVENTION

Possible versions of group I of the processes according to the invention are reproduced in the following.

In principle, with this process variant, the firing material rests on a movable support. These supports are to be housed in a base, attached via a suspension means or designed so that they require no attachment.

In particular, the following versions are suitable as base:
Fire-proof firing wadding, for example a fleece made of aluminum oxide, containing SiO₂.
Fire-proof firing sand, for example corundum.
Divided structures, open to the top, for example honeycombed structures, in which a tipping of the movable support within the framework of the firing process is possible in simple manner, for example those made of mullite.
Fire-proof packing materials which have sufficient flexibility to yield to the forces which occur during the firing process, for example those made of aluminum oxide.
Fire-proof base plates which have the same shrinkage as the firing material, for example, those made of aluminum oxide.

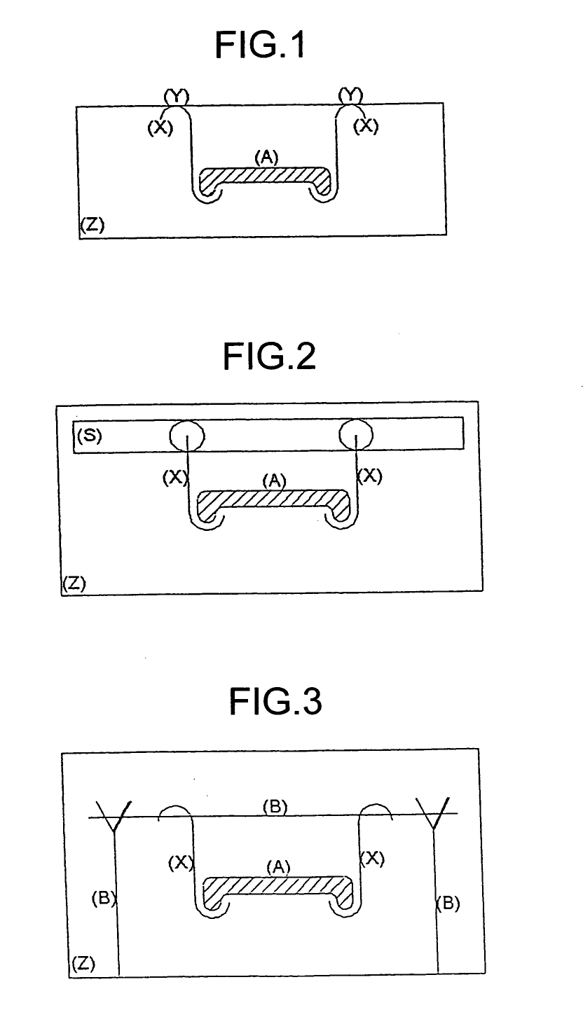

The following versions in particular are suitable as suspension means:
Suspension via fixed-mounted hooks, the firing material being fitted at a suitable position onto at least two hooks made of fire-proof material, for example aluminum oxide, and the hooks approaching each other through the forces occurring during the firing process.
FIG. 1 shows by way of example the attachment of two S-shaped hooks (X) at a fixed position (Y) within a firing chamber (Z), the firing material (A) already being fitted onto the hooks. The design of the firing material is only represented schematically here and at all other points and is not in any way to be understood as limitative.
Suspension via movably applied hooks, the firing material being fitted at a suitable position onto at least two hooks made of fire-proof material, for example aluminum oxide, and the hooks being attached movable inside or outside the firing chamber.

FIG. 2 shows by way of example the attachment of two 8-shaped hooks (X) inside the firing chamber (Z), each of the hooks being freely movable on a track (8), for example over rollers, and thus being able to yield to the forces which occur during the firing process and the firing material (A) already being fitted onto the hooks.

The hooks can also be suspended in a bar-shaped track structure (B) as shown in FIG. 3. The structure consists of vertical elements of (B), and horizontal elements of (B) which permit a suspension of the hooks (X) which support the firing material (A).

In principle, each method of attaching two hooks flexibly at a suitable height can be used.

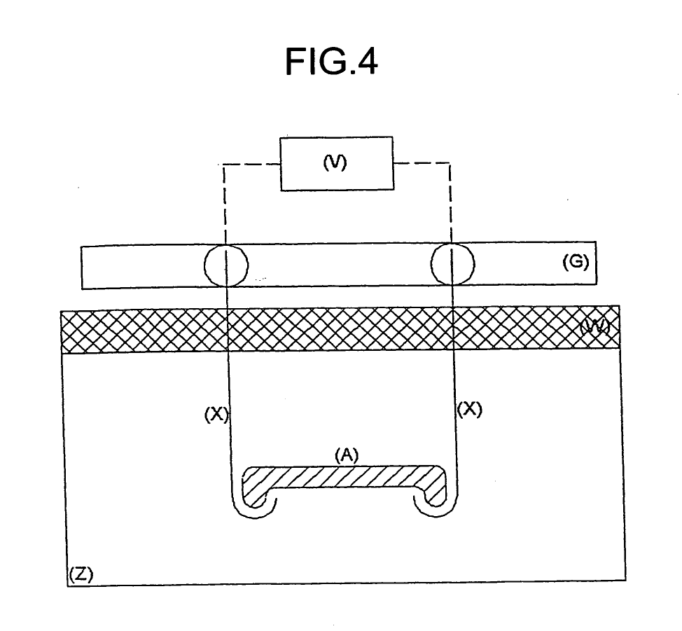

FIG. 4 shows by way of example the attachment of two hooks (X) outside the firing chamber (Z), each of the hooks being freely movable on a sliding bearing (G) and thus being able to yield to the forces which occur during the firing process. As the movable supports are located outside the firing chamber, the process is preferably applied such that the firing chamber is screened from the supports via a suitable heat insulator (W). This variant of the process according to the invention can also be improved in that the movement of the hooks in the sliding bearings does not take place exclusively through the forces occurring during the firing process, but in that the change of position of the hooks in the sliding bearings that is necessary for a force equalization is established by a mechanical, electronic and/or optical scanning device (V), and carried out mechanically for example (principle of the tangential record player).

Within the meaning of this invention, the term suspension is also taken to mean devices which use the same principle as described previously, except that the sliding bearings are attached below the firing material, these being able to be located inside or outside the firing chamber.

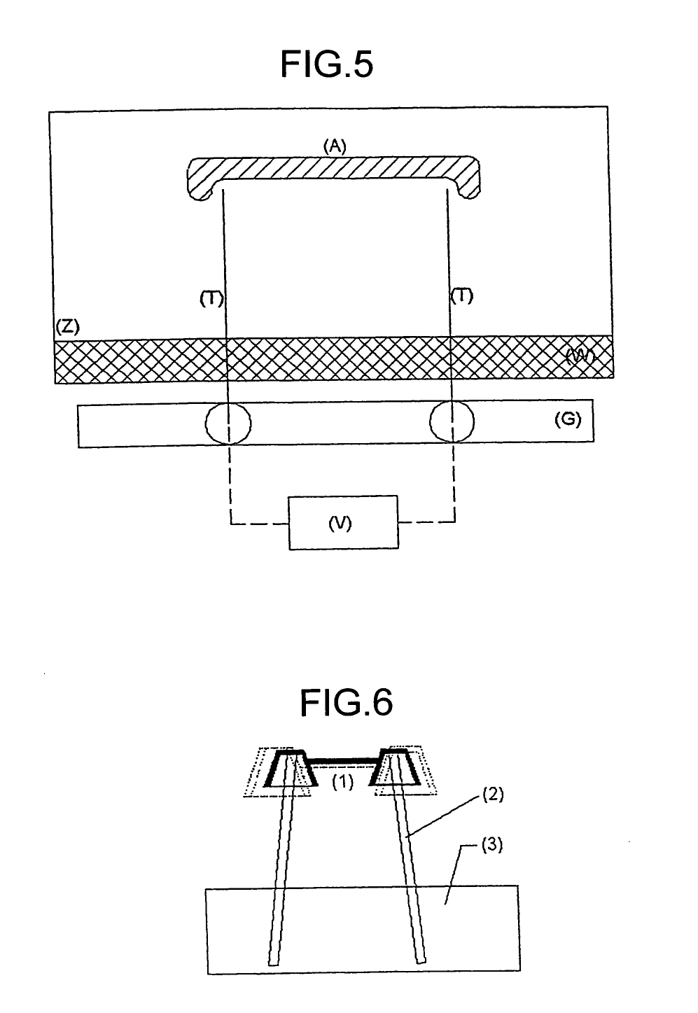

FIG. 5 shows by way of example the attachment of two props (T) for the firing material, the props being freely movable on sliding bearings (G) outside the firing chamber (Z) and thus being able to yield to the forces which occur during the firing process. A heat insulator (W) can be advantageous here just as a mechanical, electronic and/or optical scanning device (V) which establishes and carries out, for example mechanically, the change in position of the hooks in the sliding bearing necessary for a force equalization.

As supports or props, the following versions in particular are suitable:
Rods which have a cross-section which allows a minimal contact surface with the firing material, for example circular, elliptical, rectangular, in particular square and rhomboid, convex, concave, triangular, U-shaped cross-sections, the rods being able to be hollow or solid; the rods can be arranged to stand vertically or lie horizontally.
Supporting materials which have a tip which allows a minimal contact surface with the firing material, for example arrow-shaped, pyramid-shaped, conical supports which can be hollow or solid.

The following versions in particular are suitable as supporting materials which require no suspension and no attachment:
Drop-shaped bodies (tumblers) which, because of their weight distribution, come to rest in such a way that the tip of the body is perpendicular to the bearing surface at the beginning of the firing process. During the firing process, the tips of the bodies move towards each other because of the shrinkage forces which occur.

The named supports, rollers, suspensions or props can be composed of all refractable metals, metal oxides, metal carbides and their mixtures, in particular of Al₂O₃, MgO, ZrO₂, SiO₂, cordierite, SiC, WC, B₄C, W, Au, Pt.

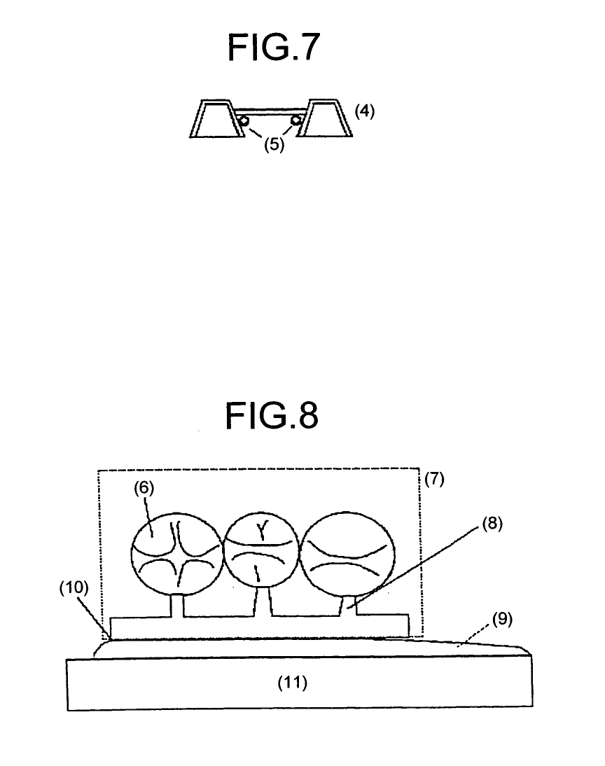

FIGS. 6 and 7 show further embodiments for group I.

FIG. 6 shows the placing of a bridge (1) on rods (2) which are housed flexibly inside so-called firing wadding (3). During the sintering process, the rods (2) can move independently in the direction of the shrinkage without tipping or deforming the bridge (1).

FIG. 7 shows another version. The prosthetic work (4) is laid on a roller-shaped structure (5), the distances between the rollers adjusting independently during the firing process. The rollers are housed on suitable suspensions or props, for example in a T- or U-shape.

With small ceramic pre-shaped items, individual or some few supports and/or props are sufficient. With large pre-shaped items, several to very many supports and/or props are required which are optionally housed such that their bearing points can adapt to the shape of the pre-shaped item to be sintered.

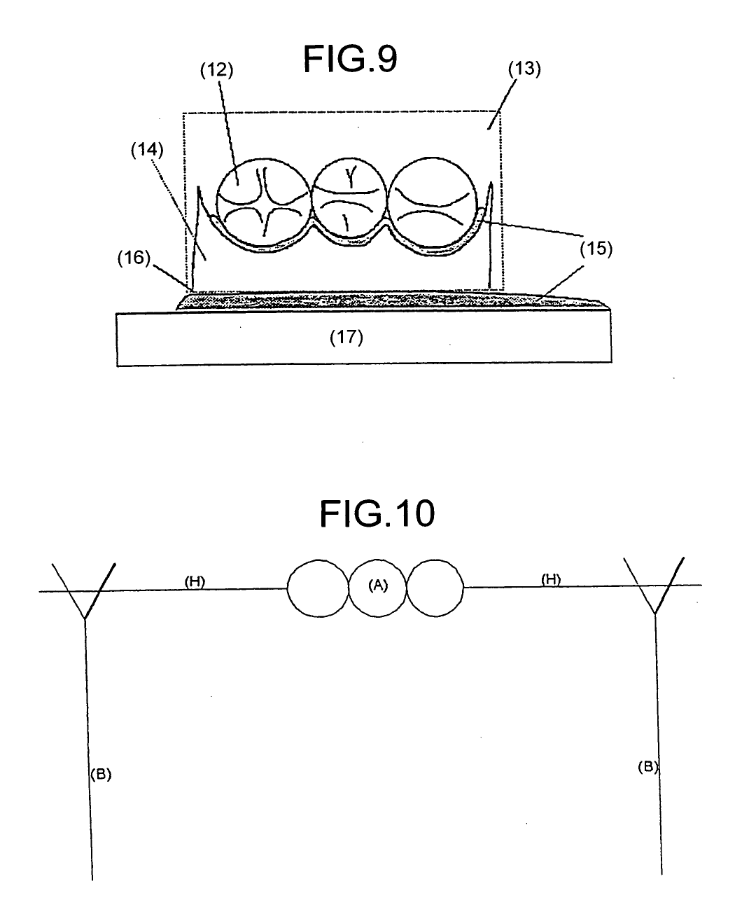

Possible versions for group II of the processes according to the invention are reproduced in the following.
The supporting pins (8) required during the milling of the work piece (6) are left in place after the milling process so that they serve as a stable multipoint support on a level firing base with the same shrinkage behaviour. The supporting device according to the invention consists in this case of the supporting pins (8) and a plane firing base made of material with the same shrinkage behaviour as the prosthetic work, preferably of the same material as the prosthetic work. Particularly preferably, a plane surface (10) is simultaneously left on the pre-shaped body during the milling process in addition to the holding pins (8), the preform (7) having to be correspondingly large in size. The supporting pins (8) are separated after the sintering in order to obtain the desired pre-shaped body. The device for the process according to the invention is placed on a fire-proof firing base (11) for example using a pourable fill material (9) or suitable support and/or props. FIG. 8 is intended to explain this version in more detail.
Cutting through supporting pins even before the sintering, fitting the remainder of the original preform (13), which after milling corresponds to a negative mould (14) of the prosthetic work, onto a plane firing base (16) using separating powder (15). Coating of the inside of the negative mould (14) likewise with separating powder (15) and laying-up of the prosthetic work (12) to be fired. The preform remainder (14) serves together with the separating powder (15) as a supporting device according to the invention (FIG. 9). The device for the process according to the invention is placed on a fire-proof firing base (17), for example using a pourable fill material (15) or suitable supports and/or props. Surprisingly, the development of sinter necks within the fill, comprising separating powder, does not take place.

All refractable metals, metal oxides, metal carbides and their mixtures, in particular Al₂O₃, MgO, ZrO₂, SiO₂, cordierite, SiC, WC, B₄C, can be used as separating powders.

FIG. 10 shows the firing material (A) resting on two Y shaped supports (8). Two holding pins (H) are attached to the firing material (A) which are either produced during the shaping process or attached to the firing material after the shaping process. The supporting pins preferably consist of the same material as the firing material, particularly preferably they are made from the same preform. Depending on the version (different or same material), this type of placement is to be allocated to group I or II. In principle, mixed versions can also be considered which are to be allocated simultaneously to the different groups.

Possible versions for group II of the processes according to the invention are reproduced in the following.
In principle, all supporting materials are suitable which have very different physical properties to the firing material itself. A contamination or bonding of the firing material with the supporting material must be excluded. The melting point of such materials preferably lies below 1450° C., particularly preferably below 1400° C. The density preferably lies somewhat above that of the firing material so that the latter can float on the supporting material. Metals or metal alloys, for example gold, can also be suitable.

Possible versions for group IV of the processes according to the invention are reproduced in the following.
The firing material rests on a gas jet, the firing material floating contact-free above the floor of the firing chamber. Control apparatuses which direct the gas jet so that the firing material can float in stable manner are also advisable. Preferably, the gases used are non-reactive gases, for example, inert gases. To optimize the gas streams, control systems of all types can be used.
The firing material rests on magnetic fields, at least one magnetic substance being attached at a suitable point in the firing material, the firing base itself or a corresponding bearing surface also being magnetic and the polarity of the two magnetic fields being identical. A magnetic design of parts of the firing material itself is also possible.

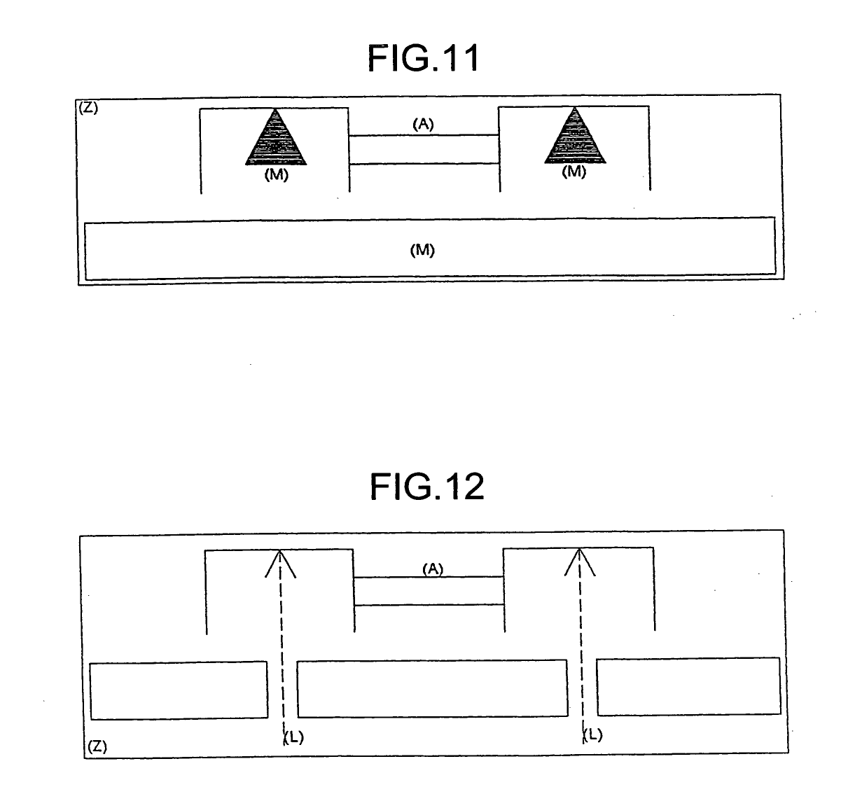

FIG. 11 shows the firing material (A) resting on a magnetic field which is generated by the magnetic bases or pre-shaped parts (M), the polarity of the magnets having to be such that the firing material floats away from the base. The whole device is located in the firing chamber (Z). Preferably, permanent magnets are used as magnets (M). The use of electromagnets or a mixed use of the magnet types which can be considered is also possible.

FIG. 12 shows the firing material (A) resting on gas streams (L), the latter exiting through a base plate provided with throughflow openings. The devices are located inside the firing chamber (Z), it being also advantageous if the floor of the firing chamber is already provided with the throughflow openings and the control and generation of the gas streams takes place outside the firing chamber.

1. A process for the dimensionally-true sintering of ceramic pre-shaped items, said process comprising:
resting a firing material during the sintering on supports not coated with metal or consisting of metal molten at the sinter temperature, which adapt independently to the shrinkage dimensions which occur during the firing process.

2. The process according to claim 1, the pre-shaped items being ceramic dental prostheses.

3. The process according to claim 1, the firing material resting on movable supporting materials which can be composed of any material which is inert vis-à-vis the firing process and does not result in adhesion to the firing material and does not contaminate the latter.

4. The process according to claim 3, the supporting materials being developed as vertically standing or horizontally lying hollow or solid rods and having a cross-section which allows a minimal contact surface with the firing material.

5. The process according to claim 3, the supporting materials having a tip which allows a minimal contact surface with the firing material, and being hollow or solid.

6. The process according to claim 1, the firing material resting on supporting material which has the same physical properties as the firing material itself.

7. The process according to claim 6, supporting material and firing material being prepared from the same preform.

8. The process according to claim 7, the firing material being connected to a plane surface via supporting pins which are cut through after sintering.

9. The process according to claim 7, the firing material resting in the negative mould obtained from preform through the milling process on a pourable fill material or on suitable supports and/or props.

10. The process according to claim 1 or 2, the firing material resting on supports which has very different physical properties to the firing material itself, wherein there is no contamination or bonding of the firing material with the supports.

11. The process according to claim 1 or 2, in which gas streams which keep the ceramic pre-shaped items floating during the sintering and are inert at the sinter temperature are used as contact-free supporting materials.

12. The process according to claim 1 or 2, in which a magnetic field which keeps the ceramic pre-shaped items floating during the sintering because of incorporated or attached magnetic constituents is used as contact-free supporting material.

13. The process according to claim 1 or 2, the preform containing aluminum oxide, zirconium oxide or mixed oxides of both.

14. The process according to claim 1, wherein said movable supports contact the firing material in pre-shaped form at a contacting portion and support said firing material during sintering thereof in order to form the ceramic pre-shaped item;
said movable supports are operatively connected to a support structure not contacting the firing material;
and the moveable supports adapt independently to the changing dimensions of the firing material during sintering by moving with respect to the support structure without substantial movement with respect to said contacting portion of the firing material.

15. The process according to claim 14, wherein the moveable supports are suspended hooks which support the firing material and the ceramic pre-shaped item during the sintering and said suspended hooks move towards or away from each other as the firing material changes dimensions.

16. The method according claim 14, wherein the moveable supports are suspending hooks which move toward or away from each other during sintering of the firing material or ceramic pre-shaped material, wherein the hooks are operatively connected to rollers moveable on a track of the support structure.

17. The method according claim 16, wherein the movable supports are operatively connected to said rollers so as to be protected by a heat insulator, and wherein said rollers are operatively connected to a mechanical, electronic and/or optical scanning device having sliding bearings which provide for force equalization during sintering.

18. The method according claim 14, wherein the moveable supports are S-shaped suspended hooks which support the firing material and ceramic pre-shaped item during the sintering and which move towards or away from each other as the firing material or ceramic pre-shaped item changes dimensions.
